(19) United States
(12) Patent Application Publication
(10) Pub. No.: US 2004/0227483 A1
(43) Pub. Date: Nov. 18, 2004

(54) Motor drive apparatus and method of controlling an operation on the same

(75) Inventors: Kenichi Katsumata, Haibara-gun (JP); Yasuyuki Mochizuki, Haibara-gun (JP); Yuichi Nakazawa, Haibara-gun (JP); Susumu Yamamoto, Haibara-gun (JP)

Correspondence Address: SUGHRUE MION, PLLC, 2100 PENNSYLVANIA AVENUE, N.W., SUITE 800, WASHINGTON, DC, 20037, US

(73) Assignee: YAZAKI CORPORATION

(21) Appl. No.: 10/816,890

(22) Filed: Apr. 5, 2004

(30) Foreign Application Priority Data
Apr. 4, 2003 (JP) P2003-101724

(51) Int. Cl. H02P 3/00

(52) U.S. Cl. 318/469; 318/286; 318/434

(57) ABSTRACT

When an operation of lowering window glass is conducted to attain a full-opened state and a lock current flows, a lowering operation is invalidated, thereby preventing the lock current from continuously flowing. When a raising operation is conducted under the full-opened state, a power window motor is operated in a direction of closing the window glass, and the in validating state is canceled. In the case where, before the full-closed state is attained, a foreign object is caught and the lock current flows, the same as above is conducted. In a raising operation of closing the window glass, the raising operation under the full-closed state is invalidated, thereby preventing the lock current from continuously flowing. When a lowering operation is conducted under the full-closed state, the power window motor is operated in the direction of opening the window glass, and the invalidating state is canceled.

### BACKGROUND OF THE INVENTION

The present invention relates to a motor drive apparatus which is suitably used in a vehicle such as an automobile, and also to a method of controlling the operation on such an apparatus. Examples of such a motor drive apparatus are a power window and an electric mirror.

An apparatus for automatically opening and closing window glass of a vehicle is usually called a power window apparatus, and opens and closes the window glass by means of an electric motor. Some of power window apparatuses are provided with jamming protection as a countermeasure for preventing a foreign object from being caught by window glass. In a usual power window apparatus, when window glass is fully opened or closed, or when a foreign object is caught during a process of raising the window glass, the motor current is remarkably increased, and therefore the motor current must be limited so that the increase of the motor current is controlled.

A power window current detection circuit which can detect a motor current to control the motion of window glass has been proposed (for example, see JP-A-9-209650).

FIG. 8 is a block diagram showing the configuration of the power window current detection circuit proposed in Patent Reference 1. In the power window current detection circuit shown in the figure, a current flowing to a power window motor 1 is detected through a shunt resistor 2 which is connected in series to the power window motor 1, a current detecting portion 3 compares the level of the detected current with a predetermined reference value, and, if the current level exceeds the reference value, a timer portion 4 measures the duration period, so that the power window motor 1 can be controlled in the case where the detected current continuously exceeds the predetermined reference value for a predetermined period.

When a full-open current is detected, for example, a control of stopping the power window motor 1 is enabled, and, when a full-close current is detected, a control of stopping the power window motor 1 is enabled. When a lock current flows during a process of raising the window glass, it is judged that a foreign object is caught, and a control of reversely rotating the power window motor 1 to lower the window glass is enabled. The forward and reverse rotations of the power window motor 1 are switched over by changing the polarity of the voltage to be applied to the power window motor 1. In order to perform the changeover, relays 5, 6 and a solenoid driving portion 7 for driving coils of the relays 5, 6 are disposed.

In the conventional power window current detection circuit, particularly, the detection level of the motor current can be set in two stages, so that the lock current, the full-open current, and the full-close current can be detected even when the value of the motor current is lowered due to change over time. Namely, the current detecting portion 3 comprises two comparators 301 and 302. A voltage which is proportional to the current flowing through the shunt resistor 2 is applied to one input terminal of each of the comparators. A comparison voltage Vref1 which is obtained by division based on a ratio of the resistance of a resistor 311 to the total resistance of resistors 312 and 313 is applied to the other input terminal of the comparator 301. A comparison voltage Vref2 which is obtained by division based on a ratio of the total resistance of the resistors 311 and 312 to the resistance of the resistor 313 is applied to the other input terminal of the comparator 302.

Since the comparison voltages Vref1, Vref2 (Vref1>Vref2) are set, the locked state can be detected even when the motor current is reduced from the initial value as a result of change over time. FIG. 9 is a graph showing relationships between the position of the window glass and a detection value of the motor current. In the figure, the comparison voltage Vref1 corresponds to a detection level L1, and the voltage Vref2 to a detection level L2. In this case, the voltage Vref1 is set to a value at which the detection level L1 is lower than the lock current in an initial state, and the voltage Vref2 is set to a value at which the detection level L2 is lower than the lock current in a state of change over time. Therefore, the locked state can be detected even when the motor current is reduced as a result of change over time.

The conventional power window current detection circuit is configured so that, in an initial state, the locked state is not detected at the timing when the motor current exceeds the detection level L1, but detected only after the state where the motor current exceeds the detection level L1 continues for a period T1. In a state of change over time, the locked state is not detected at the timing when the motor current exceeds the detection level L2, but detected only after the state where the motor current exceeds the detection level L2 continues for a period T2 (>T1).

However, a conventional power window apparatus has the following problem. When a foreign object is caught during a process of raising window glass, when an operation in an opening direction is conducted under the state where window glass is fully opened, or when an operation in a closing direction is conducted under the state where window glass is fully closed, a large current or a lock current flows to a semiconductor device which drives a window motor, and the semiconductor device generates heat. When the heat generated state is continued, the life of the semiconductor device is shortened, and in the worst case the semiconductor device is broken.

### SUMMARY OF THE INVENTION

The invention has been conducted in view of the above-mentioned circumstances. It is an object of the invention to provide a motor drive apparatus in which, even when an operation in an opening direction is conducted under the state where window glass is fully opened, when an operation in a closing direction is conducted under the state where window glass is fully closed, or when a foreign object is caught during a process of raising window glass, for example, a lock current does not continuously flow to a semiconductor device that drives the window motor, and also a method of controlling an operation on such an apparatus.

(1) A motor drive apparatus comprising:

a motor current detecting section which detects a motor current when a movable member driven by a motor is moved;

a lock current judging section which monitors the motor current detected by the motor current detecting section to make a judgment on a lock current that is to flow when motion of the movable member is set to a locked state;

a switch operation invalidation setting section which, when a judgment that the motor current when the movable member is moved is the lock current is made, invalidates a switch operation in a movement direction of the movable member at a timing of the judgment; and

a switch operation invalidation setting canceling section which, when a switch operation of moving the movable member in an opposite direction is conducted under a state where invalidation of a switch operation is set by the switch operation invalidation setting section, cancels the setting of switch operation invalidation by the switch operation invalidation setting section.

According to the configuration, when the motor current in the case where the movable member is moved reaches the lock current, a switch operation of the movement direction of the movable member at the timing is invalidated, and, when a switch operation of moving the movable member in the opposite direction is conducted under the state where a switch operation is invalidated, the switch operation invalidation setting state is cancelled.

Therefore, the lock current does not continuously flow after the timing when the locked state is set. Consequently, heat generation of a semiconductor device for supplying a current to the motor is suppressed, so that the device can be prevented from being thermally broken, and the life of the device can be prolonged.

(2) A motor drive apparatus comprising:

a motor current detecting section which detects a motor current when a movable member driven by a motor is moved;

a lock current judging section which monitors the motor current detected by the motor current detecting section to make a judgment on a lock current that is to flow when motion of the movable member is set to a locked state;

a switch operation invalidation setting section which, when a judgment that the motor current when the movable member is moved is the lock current is made, invalidates a switch operation of a movement direction of the movable member at a timing of the judgment, only for a predetermined period; and

a switch operation invalidation setting canceling section which, when a switch operation of moving the movable member in an opposite direction is conducted under a state where invalidation of a switch operation is set by the switch operation invalidation setting section, cancels the setting of switch operation invalidation by the switch operation invalidation setting section.

According to the configuration, when the motor current in the case where the movable member is moved reaches the lock current, a switch operation of the movement direction of the movable member is invalidated for the predetermined period with starting from this timing, and, when a switch operation of moving the movable member in the opposite direction is conducted during the period in which a switch operation is invalidated, the switch operation invalidation setting state is cancelled. When the motor current is equal to the lock current even at a timing when the predetermined period elapses, a switch operation in the same direction is again invalidated only for the predetermined period.

Therefore, the lock current does not continuously flow for the predetermined period after the timing when the locked state is set. Consequently, heat generation of a semiconductor device for supplying a current to the motor is suppressed, so that the device can be prevented from being thermally broken, and the life of the device can be prolonged. When the predetermined period of invalidating a switch operation elapses, a switch operation in the same direction is again enabled. In the case where the window glass is erroneously stopped in the course of fully closing the window glass because of, for example, change over time of a door, even when a lowering operation is not conducted, a raising operation is again enabled after elapse of the predetermined period, with the result that the possibility that the window glass can be fully closed is enhanced. Since the possibility that the window glass can be fully closed is enhanced, it is expected that an anticrime measure against vehicle theft and the like can be improved.

(3) A method of controlling an operation on a movable member driven by a motor, the method comprising the steps of:

invalidating, when a motor current in a case where the movable member is moved reaches a lock current that is to flow when motion of the movable member is set to a locked state; a switch operation in a direction of moving the movable member at this timing; and

canceling the switch operation invalidation setting state by conducting a switch operation of moving the movable member in an opposite direction under a state where the switch operation is invalidated.

According to the method, the lock current does not continuously flow after the timing when the locked state is set. Consequently, heat generation of a semiconductor device for supplying a current to the motor is suppressed, so that the device can be prevented from being thermally broken, and the life of the device can be prolonged.

(4) A method of controlling an operation on a movable member driven by a motor, the method comprising the steps of:

invalidating, when a motor current in a case where the movable member is moved reaches a lock current that is to flow when motion of the movable member is set to a locked state, a switch operation in a direction of moving the movable member at this timing only for a predetermined period;

canceling the switch operation invalidation setting state by conducting a switch operation of moving the movable member in an opposite direction during the predetermined period of invalidating a switch operation; and

invalidating again, when the motor current corresponds to the lock current even at a timing when the predetermined period elapses, a switch operation in the same direction only for the predetermined period.

According to the method, the lock current does not continuously flow for the predetermined period after the timing when the locked state is set. Consequently, heat generation of a semiconductor device for supplying a current to the motor is suppressed, so that the device can be prevented from being thermally broken, and the life of the device can be prolonged. When the predetermined period of invalidating a switch operation elapses, a switch operation in the same direction is again enabled. In the case where the window glass is erroneously stopped in the course of fully closing the window glass because of, for example, change over time of a door, even when an operation of lowering the window glass is not conducted, an operation of raising the window glass is again enabled after elapse of the predetermined period, with the result that the possibility that the window glass can be fully closed is enhanced. Since the possibility that the window glass can be fully closed is enhanced, it is expected that an anticrime measure against vehicle theft and the like can be improved.

### BRIEF DESCRIPTION OF THE DRAWINGS

FIG. 1 is a block diagram showing the configuration of a power window apparatus of a first embodiment of the invention.

FIG. 2 is a time chart illustrating the operation of a control unit of the power window apparatus of the first embodiment of the invention.

FIG. 3 is a block diagram showing the configuration of the control unit of the power window apparatus of the first embodiment of the invention.

FIG. 4 is a flowchart illustrating the operation of the control unit of the power window apparatus of the first embodiment of the invention.

FIG. 5 is a block diagram schematically showing the configuration of a power window apparatus of a second embodiment of the invention.

FIG. 6 is a time chart illustrating the operation of a control unit of the power window apparatus of the second embodiment of the invention.

FIG. 7 is a flowchart illustrating the operation of the control unit of the power window apparatus of the second embodiment of the invention.

FIG. 8 is a block diagram showing the configuration of a conventional power window current detection circuit.

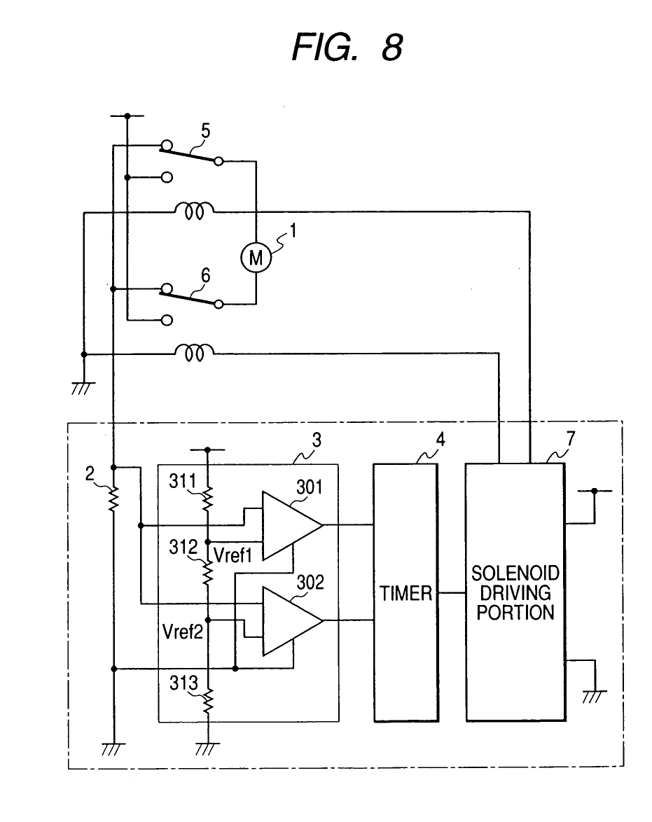

FIG. 9 is a view illustrating a lock detecting operation of the conventional power window current detection circuit.

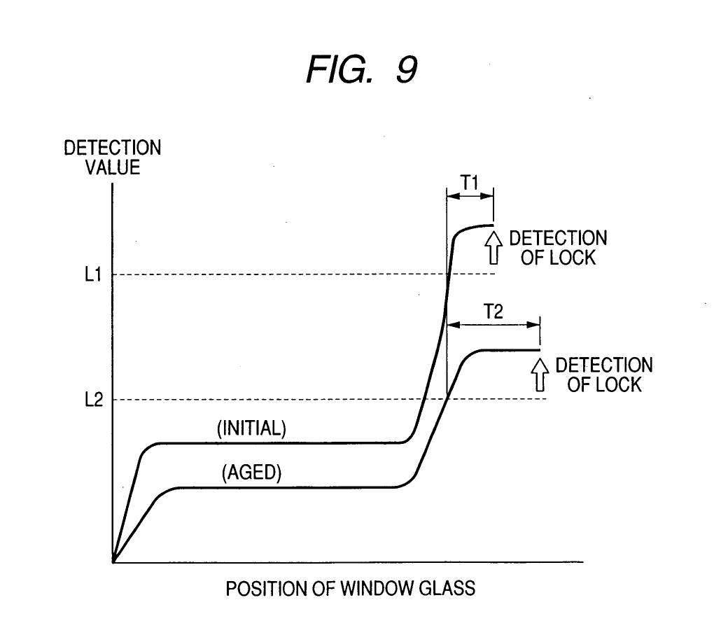

### DETAILED DESCRIPTION PREFERRED EMBODIMENTS

Hereinafter, embodiments of the invention will be described in detail with reference to the accompanying drawings.

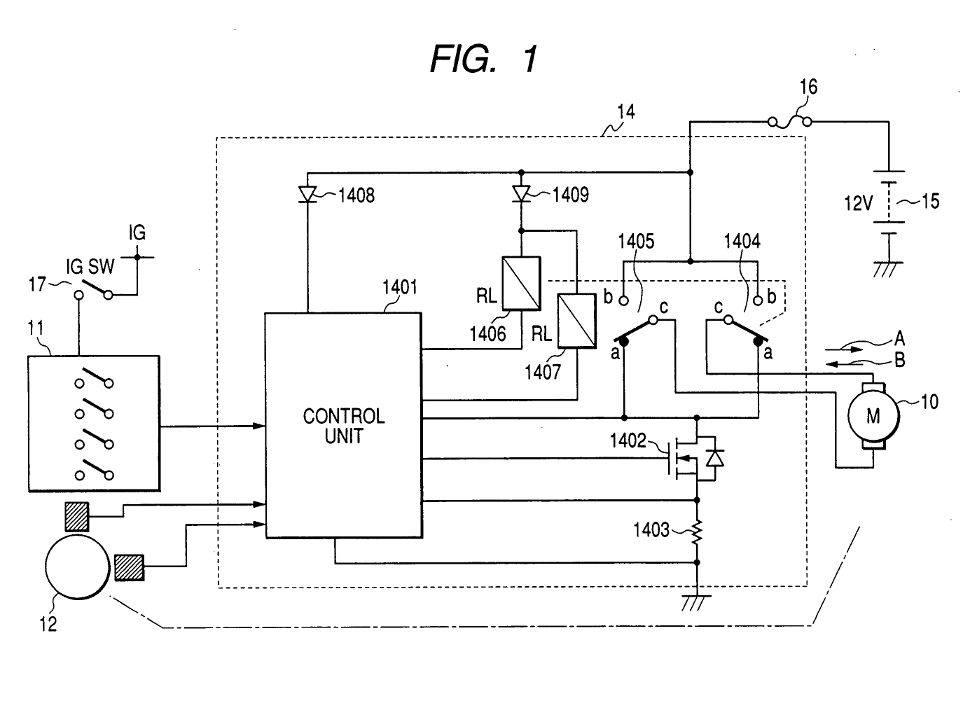

FIG. 1 is a block diagram showing the configuration of a power window apparatus of a first embodiment of the invention. In all of the embodiments described below, the motor drive apparatus is a power window apparatus, and the movable member is window glass.

Referring to FIG. 1, the power window apparatus of the embodiment comprises: a power window motor 10 for raising and lowering power window which is not shown; and a power window ECU 14 which controls the power window motor 10 on the basis of output signals of a switch module 11 and a two-phase pulse sensor 12 that are used for operating the power window.

The power window motor 10 and the power window ECU 14 are powered by a battery 15 mounted on a vehicle. A fuse 16 is interposed between the battery 15 and the power window ECU 14. An ignition switch (IGSW) 17 is connected to the switch module 11.

In the switch module 11, various switches such as a manual up/down switch for manually raising and lowering the window glass, and an automatic up/down switch for automatically raising and lowering the window glass are disposed. The manual up/down switch is configured so that, only when a switch knob which is not shown is pushed up, the window glass is raised, and, only when the switch knob is pushed down, the window glass is lowered. The automatic up/down switch is configured so that, when a switch knob which is not shown is once clicked up, the window glass is raised to the full-closed state unless the switch knob is clicked down, and, when the switch knob is once clicked down, the window glass is lowered to the full-opened state unless the switch knob is clicked up.

The two-phase pulse sensor 12 detects the number of rotations of the power window motor 10. The power window ECU 14 calculates the position of the window glass from the number of rotations detected by the two-phase pulse sensor 12. The power window ECU 14 comprises: a control unit 1401; an FET (Field Effect Transistor) 1402 which is a semiconductor device for driving the power window motor 10; a shunt resistor 1403 which is interposed between the drain of the FET 1402 and the ground; relay contacts 1404, 1405 which switch over the polarity of a voltage to be applied to the power window motor 10, thereby causing the power window motor 10 to rotate forwardly or reversely; a relay coil 1406 which drives the relay contact 1404; a relay coil 1407 which drives the relay contact 1405; a reverse blocking diode 1408 which is interposed between the control unit 1401, and a power source input terminal (not shown) and the battery 15; and a reverse blocking diode 1409 which is interposed between the relay coils 1406 and 1407 and the battery 15.

In the relay contact 1404, a common contact c is normally connected to a contact a, and, when the relay coil 1406 is energized, the common contact is switched to be connected to a contact b. In the relay contact 1405, similarly, a common contact c is normally connected to a contact a, and, when the relay coil 1407 is energized, the common contact is switched to be connected to a contact b. The embodiment is configured so that, when the power window motor 10 is to be rotated in the direction of raising the window glass (referred to as forward rotation), only the relay contact 1404 is operated, and, when the power window motor 10 is to be rotated in the direction of lowering the window glass (referred to as reverse rotation), only the relay contact 1405 is operated. When only the relay contact 1404 is operated, a current Ia in the direction of the arrow A flows to the power window motor 10, and, when only the relay contact 1405 is operated, a current Ib in the direction of the arrow B flows to the power window motor 10.

Immediately after the relay contact 1404 or 1405 is switched over, the control unit 1401 applies a voltage to the gate of the FET 1402 to set the FET 1402 to the ON-state. In this case, when the relay contact 1404 is switched over as described above, the current Ia in the direction of the arrow A flows to the power window motor 10. When the relay contact 1405 is switched over, the current Ib in the direction of the arrow B flows to the power window motor 10. Since the FET 1402 is in the ON-state and a current flows to the power window motor 10, a voltage which is proportional to the present value of the current is generated across the shunt-resistor 1403, and the voltage is detected by the control unit 1401.

The control unit 1401 detects a lock current on the basis of the value of the motor current, and, when the lock current is detected, conducts a control of disabling an operation of the same direction. When the lock current is detected during an operation of raising the window glass, for example, the energization of the relay coil 1406 is stopped, and the common contact c of the relay contact 1404 is switched to be connected to the contact a. Also in the case where the lock current is detected before the full-closed state is attained, i.e., the case where it is detected that a foreign object is caught, similarly, the energization of the relay coil 1406 is stopped, and the common contact c of the relay contact 1404 is switched to be connected to the contact a. By contrast, when the lock current is detected during an operation of lowering the window glass, the energization of the relay coil 1407 is stopped, and the common contact c of the relay contact 1405 is switched to be connected to the contact a.

The control unit 1401 invalidates an operation on each of the switches when the lock current is detected. In the case where the full-closed state is attained as a result of a raising operation, for example, a raising operation on each of the manual and automatic up/down switches is not accepted, or a raising operation is invalidated. In the case where the full-opened state is attained as a result of a lowering operation, similarly, a lowering operation on each of the manual and automatic up/down switches is not accepted, or a lowering operation is invalidated. After a raising or lowering operation is invalidated, when an operation which is opposite to the invalidated operation is conducted, the invalidating operation is canceled. In the case where a raising operation is invalidated, when a lowering operation is conducted, for example, the invalidation of a raising operation is canceled. In the case where a lowering operation is invalidated, when a raising operation is conducted, the invalidation of a lowering operation is canceled.

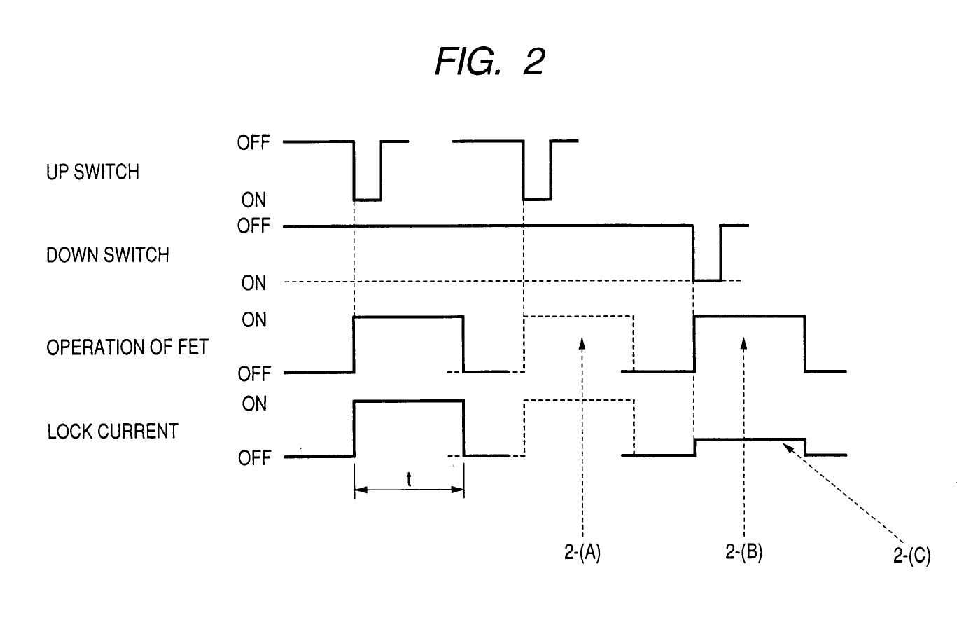

FIG. 2 is a time chart showing the operation of the control unit 1401 in response to a switch operation under the full-closed or caught state.

As shown in FIG. 2, when the up switch is turned ON under the full-closed or caught state, the FET 1402 is set to the ON-state. When the FET 1402 is set to the ON-state, the motor current flows to the power window motor 10, and the motor operates. However, the lock current flows because the window glass is in the full-closed state. When the lock current flows for a period t, the control unit 1401 turns OFF the FET 1402. Even when the up switch is again turned ON under this state, the control unit 1401 does not accept this operation, and does not set the FET 1402 to the ON-state (2-(A)). When the down switch is turned ON under this state, the control unit 1401 accepts this operation to set the FET 1402 to the ON-state (2-(B)). In the case where the down switch is turned ON, the window glass is lowered, and hence the motor current is not equal to the lock current (2-(C)). In the case of a lowering operation, a process opposite to that described above is performed.

As described above, even when a raising operation is conducted under the state where the window glass is fully closed or a foreign object is caught, or when a lowering operation is conducted under the state where the window glass is fully opened, the operation is invalidated, and hence the lock current does not continuously flow. As a result, heat generation of the FET 1402 is suppressed, so that the FET 1402 can be prevented from being thermally broken, and the life of the FET can be prolonged.

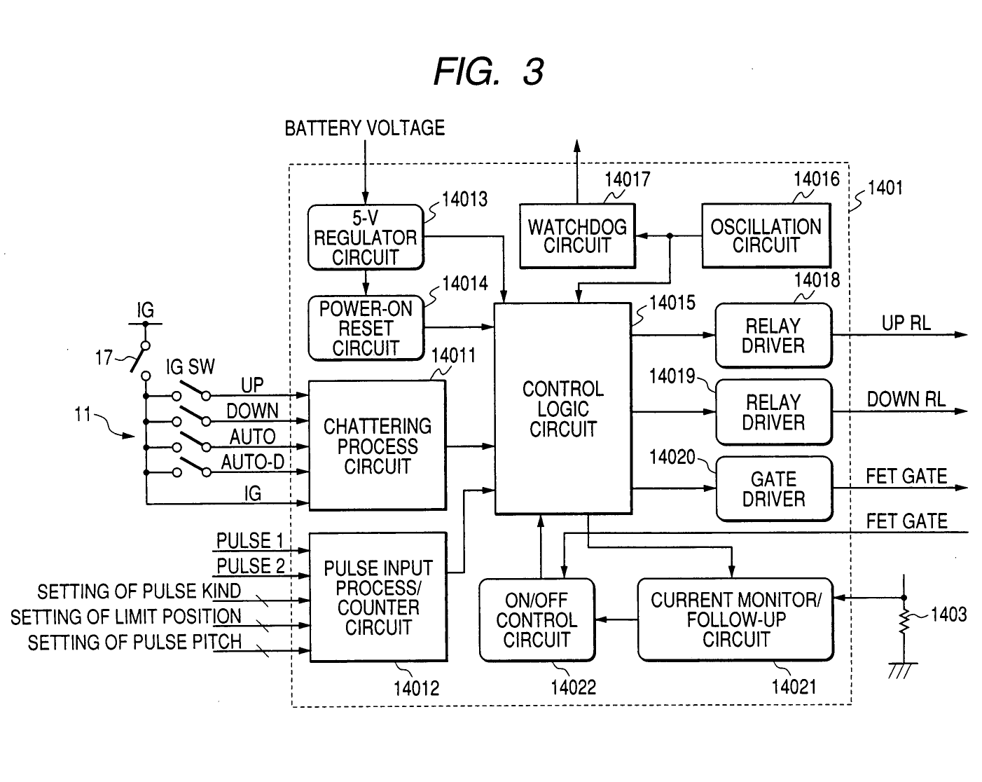

Next, the configuration of the control unit 1401 will be described in detail with reference to the block diagram of FIG. 3.

As shown in FIG. 3, the control unit 1401 comprises a chattering process circuit 14011, a pulse input process/counter circuit 14012, a 5-V regulator circuit 14013, a power-ON reset circuit 14014, a control logic circuit 14015, an oscillation circuit 14016, a watchdog circuit 14017, relay drivers 14018 and 14019, a gate driver 14020, a current monitor circuit 14021, and an ON/OFF control circuit 14022.

The chattering process circuit 14011 shapes the waveform of a switch signal of the ignition switch 17, and the waveforms of the switch signals of the switches of the switch module 11, and supplies the resulting shaped switch signals to the control logic circuit 14015. The pulse input process/counter circuit 14012 conducts operations such as counting of output pulses of the two-phase pulse sensor 12, and supplies a result of the counting to the control logic circuit 14015. The 5-V regulator circuit 14013 converts the battery voltage (for example, 12 V) to 5 V at which the control unit 1401 is operable.

When the battery voltage is applied, the power-ON reset circuit 14014 supplies a reset signal to the control logic circuit 14015, to reset the control logic circuit 14015. The oscillation circuit 14016 produces a basic clock signal for enabling the control logic circuit 14015 to operate, and supplies the basic clock signal to the control logic circuit 14015. The watchdog circuit 14017 monitors the operation of the oscillation circuit 14016. The relay driver 14018 drives the relay coil 1406. The relay driver 14019 drives the relay coil 1407. The gate driver 14020 drives the FET 1402.

The current monitor/follow-up circuit 14021 monitors the instantaneous value Vins of the motor current flowing through the shunt resistor 1403, and controls the mean value Vc. The ON/OFF control circuit 14022 monitors the drain voltage of the FET 1402, and produces ON/OFF control timings of the FET 1402 in accordance with the level of the voltage. The control logic circuit 14015 performs a state control such as raising and lowering, a relay control, an FET control, an FET overheat protection control, a start mask control, etc.

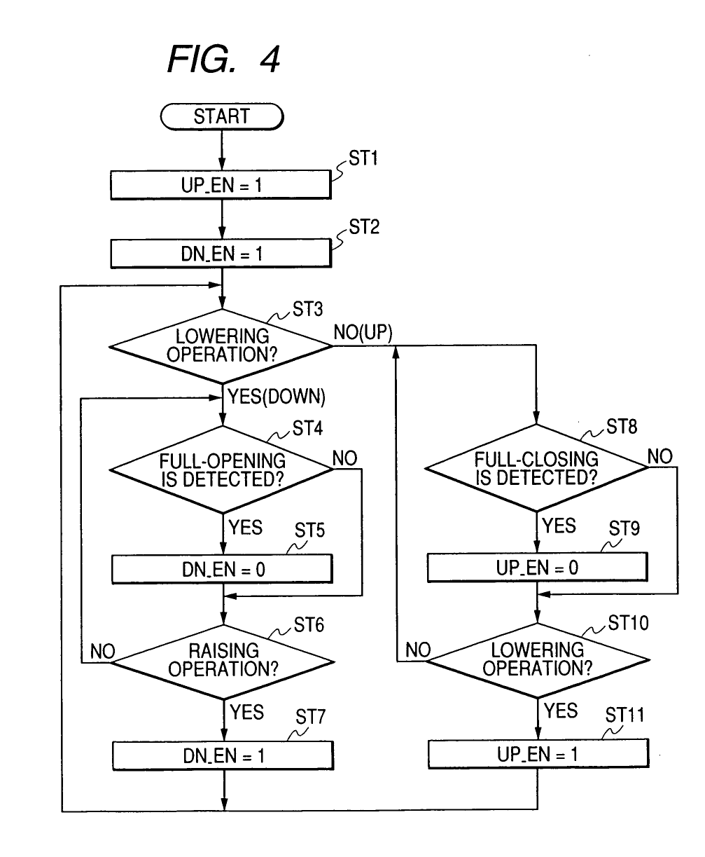

Next, the operation of the control unit 1401 of the power window system of the embodiment will be described with reference to the flowchart shown in FIG. 4. The following description is made under the assumption that the window glass is presently in the full-closed state.

First, a flag UP_EN for enabling the up switch to be operated is set to “1” (step 1). Then, a flag DN_EN for enabling the down switch to be operated is set to “1” (step 2). After the flags are set, it is judged whether a lowering operation is conducted or not (step 3). If a lowering operation is conducted, the control unit 1401 operates the relay driver 14019 so as to drive the relay coil 1407, whereby the common contact c of the relay contact 1405 is switched to be connected to the contact b. As a result, a current flows to the power window motor 10 in a direction by which the power window motor 10 is reversely rotated, and the window glass is lowered.

After the relay driver 14019 is operated, the control unit 1401 monitors the value of the motor current to judge whether the full-opened state is attained or not (step 4). If the full-opened state is attained, the flag DN_EN is set to “0” (step 5) to stop the operation of the relay driver 14019, thereby invalidating a lowering operation. Then, it is judged whether a raising operation is conducted or not (step 6). If a raising operation is not conducted, the process returns to step 4. If the raising operation is conducted, the flag DN_EN is set to “1” (step 7), and the process returns to step 3.

By contrast, if it is judged in step 4 that the full-opened state is not attained, the process jumps directly to step 6 to conduct the judgment. Namely, in steps 4 to 7, if a lowering operation is conducted and the window glass is in the full-opened state, the flag DN_EN is set to “0” to invalidate a further lowering operation, and, if a raising operation is conducted under the lowering operation invalidation setting state, the flag DN_EN is set to “1” to cancel the invalidation of the lowering operation. When the lowering operation is stopped in the course of fully opening the window glass, the processes of steps 4 to 6 are continued until the lowering operation is restarted or a raising operation is conducted.

When a raising operation is conducted under the full-opened state or in the course of fully opening the window glass, the control unit 1401 operates the relay driver 14018 so as to drive the relay coil 1406, whereby the common contact c of the relay contact 1404 is switched to be connected to the contact b. As a result, a current flows to the power window motor 10 in a direction by which the power window motor 10 is forwardly rotated, and the window glass is raised.

After the judgment of step 3, the process proceeds to step 8 to judge whether the full-closed state is attained or not. If the full-closed state is attained, the flag UP_EN is set to “0” (step 9) to stop the operation of the relay driver 14018, thereby invalidating a raising operation. Then, it is judged whether a lowering operation is conducted or not (step 10). If a lowering operation is not conducted, the process returns to step 8. If a lowering operation is conducted, the flag UP_EN is set to “1” (step 11) to validate a raising operation, and the process returns to step 3.

By contrast, if it is judged in step 8 that the full-closed state is not attained, the process jumps to step 10 to conduct the judgment. Namely, in steps 8 to 11, if a raising operation is conducted and the window glass is in the full-closed state, the flag UP_EN is set to “0” to invalidate a further raising operation, and, if a lowering operation is conducted under the raising operation invalidation setting state, the flag UP_EN is set to “1” to cancel the invalidation of a raising operation. When the raising operation is stopped in the course of fully closing the window glass, the processes of steps 8 to 10 are continued until the raising operation is restarted or a lowering operation is conducted.

When a foreign object is caught in the course of conducting a raising operation to raise the window glass and a lock current is produced, the resulting state is identical with that of the detection of the full closing in step 8, and hence the raising operation is invalidated, so that a further raising operation cannot be conducted unless a lowering operation is thereafter conducted.

As described above, in the power window apparatus of the embodiment, when an operation of lowering the window glass is conducted to attain the full-opened state and the lock current flows, a lowering operation is inhibited from being accepted, thereby preventing the lock current from continuously flowing to the power window motor 10. When a raising operation is conducted under the full-opened state of the window glass, the power window motor 10 is operated in the direction of closing the window glass, and the state of inhibiting the acceptance of a lowering operation is canceled. Similarly, when an operation of raising the window glass is conducted to attain the full-closed state and the lock current flows, a raising operation is inhibited from being accepted, thereby preventing the lock current from continuously flowing to the power window motor 10. When a lowering operation is conducted under the full-closed state of the window glass, the power window motor 10 is operated in the direction of opening the window glass, and the state of inhibiting the acceptance of a raising operation is canceled. In the case where, during a raising operation, a foreign object is caught before the full-closed state is attained, and the lock current flows, a further raising operation is inhibited from being accepted, thereby preventing the lock current from continuously flowing. When a lowering operation is conducted under this state, the power window motor 10 is operated in the direction of opening the window glass, and the state of inhibiting the acceptance of a raising operation is canceled.

Therefore, the lock current does not continuously flow after the timing when the locked state is set. Consequently, heat generation of the FET 1402 is suppressed, so that the FET 1402 can be prevented from being thermally broken, and the life of the FET can be prolonged.

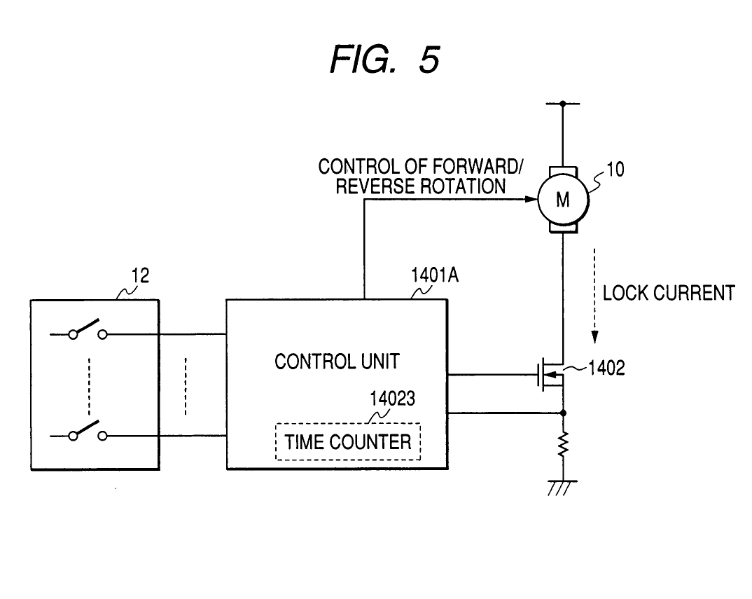

FIG. 5 is a block diagram schematically showing the configuration of a power window apparatus of a second embodiment of the invention. Although the function is partly different, the power window apparatus of the embodiment is configured in the same manner as that of the above-described first embodiment, and hence FIGS. 1 and 3 are incorporated in the description of the detailed configuration.

In the power window apparatus of the first embodiment, when the window glass is set to the locked state such as the full-closed, full-opened, or caught state, an operation of the same direction is completely inhibited until an operation of the opposite direction is conducted. By contrast, in the power window apparatus of the embodiment, a switch operation acceptance inhibition period is disposed, and an operation of the same direction is inhibited for the period. However, an operation of the opposite direction is validated during the switch operation acceptance inhibition period. In order to set the switch operation acceptance inhibition period, a control unit 1401A of the power window apparatus of the embodiment comprises a time counter 14023.

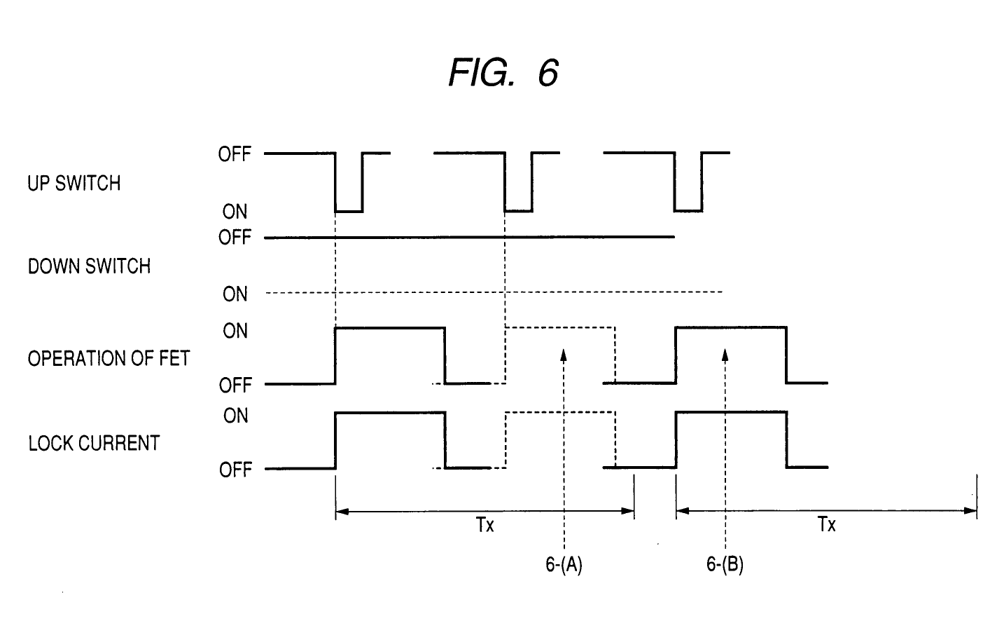

FIG. 6 is a time chart showing the operation of the control unit 1401A in response to a switch operation under the full-closed or caught state.

As shown in FIG. 6, when the up switch is turned ON under the full-closed or caught state, the FET 1402 is set to the ON-state. When the FET 1402 is set to the ON-state, the motor current flows to the power window motor 10, and the motor operates. However, the lock current flows because the window glass is in the full-closed state. At the same time when the lock current flows, the time counter 14023 starts to count the switch operation acceptance inhibition period Tx.

When the lock current flows for a period t, the control unit 1401A turns OFF the FET 1402. During the process of counting the switch operation acceptance inhibition period Tx, an operation on the up switch is not accepted, and hence the FET 1402 is not set to the ON-state (6-(A)). When an operation of the opposite direction is conducted or the down switch is turned ON during the switch operation acceptance inhibition period Tx, the control unit 1401A accepts the operation and sets the FET 1402 to the ON-state. When the switch operation acceptance inhibition period Tx elapses, an operation of the same direction, i.e., an operation on the up switch is acceptable. In the case of the locked state, the process of counting the switch operation acceptance inhibition period Tx is again started (6-(B)). Also during this period, an operation of the opposite direction is acceptable.

As described above, the lock current does not continuously flow for the switch operation acceptance inhibition period Tx after the timing when the locked state is set. Therefore, heat generation of the FET 1402 is suppressed, so that the FET 1402 can be prevented from being thermally broken, and the life of the FET can be prolonged. When the switch operation acceptance inhibition period Tx elapses, a switch operation in the same direction is again enabled. In the case where the window glass is erroneously stopped in the course of fully closing the window glass because of, for example, change over time of a door, even when a lowering operation is not conducted, a raising operation is again enabled after elapse of the switch operation acceptance inhibition period Tx, with the result that the possibility that the window glass can be fully closed is enhanced. Since the possibility that the window glass can be fully closed is enhanced, it is expected that an anticrime measure against vehicle theft and the like can be improved.

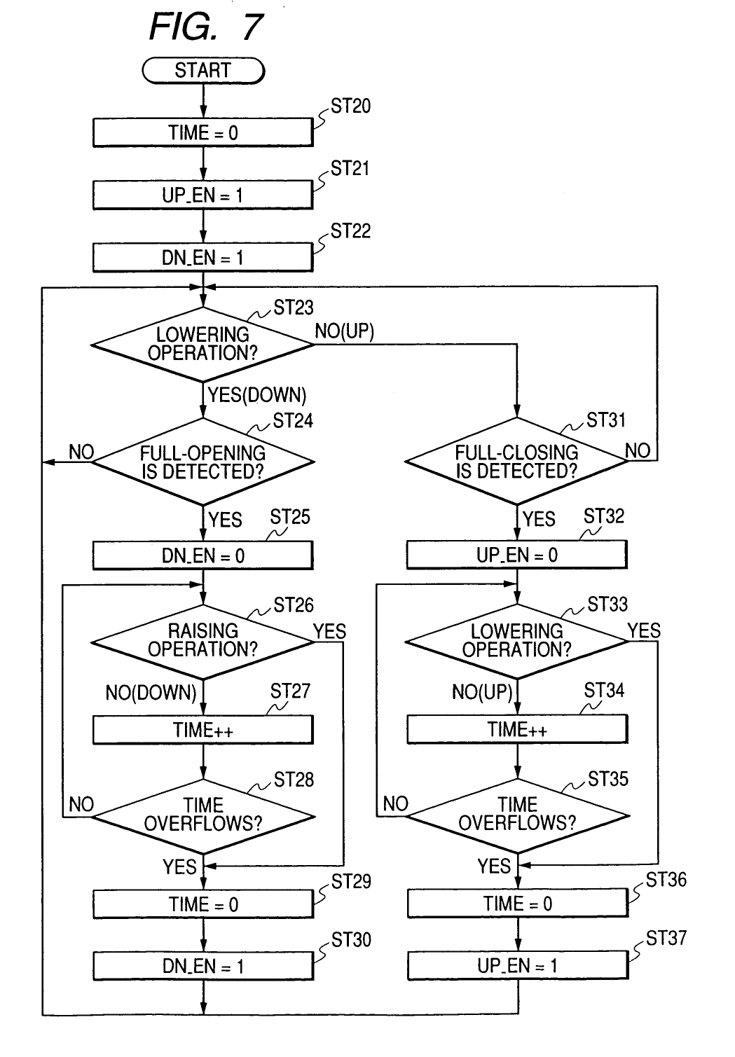

Next, the operation of the control unit 1401A of the power window system of the embodiment will be described with reference to the flowchart shown in FIG. 7. The following description is made under the assumption that the window glass is presently in the full-closed state.

First, the value of the time counter is set to “0” (step 20). Then, the flag UP_EN for enabling the up switch to be operated is set to “1” (step 21). The flag DN_EN for enabling the down switch to be operated is set to “1” (step 22). After the flags are set, it is judged whether a lowering operation is conducted or not (step 23). If a lowering operation is conducted, the control unit 1401A operates the relay driver 14019 so as to drive the relay coil 1407, whereby the common contact c of the relay contact 1405 is switched to be connected to the contact b. As a result, a current flows to the power window motor 10 in a direction by which the power window motor 10 is reversely rotated, and the window glass is lowered.

After the relay driver 14019 is operated, the control unit monitors the value of the motor current to judge whether the full-opened state is attained or not (step 24). If the full-opened state is attained, the flag DN_EN is set to “0” (step 25) to stop the operation of the relay driver 14019, thereby invalidating a lowering operation. Then, it is judged whether a raising operation is conducted or not (step 26). If a raising operation is not conducted, the value of the timer counter is incremented in order to measure the switch operation acceptance inhibition period Tx (step 27). Thereafter, it is judged whether the value of the timer counter overflows or not, or whether the value is larger than that corresponding to the switch operation acceptance inhibition period Tx or not (step 28).

If it is judged that the value of the timer counter is not larger than that corresponding to the switch operation acceptance inhibition period Tx, the process returns directly to step 26. If the period Tx elapses, the value of the timer counter is returned to the initial value or “0” (step 29). If a raising operation is conducted during the switch operation acceptance inhibition period Tx, the process jumps directly from step 26 to step 29. In step 29, the value of the timer counter is returned to the initial value. Then, the flag DN_EN is set to “1” (step 30) to enable a lowering operation, and thereafter the process returns to step 23. By contrast, if it is judged in step 24 that the full-opened state is not attained, the process returns directly to step 23.

When a raising operation is conducted under the full-opened state or in the course of fully opening the window glass, the control unit 1401A operates the relay driver 14018 so as to drive the relay coil 1406, whereby the common contact c of the relay contact 1404 is switched to be switched to the contact b. As a result, a current flows to the power window motor 10 in a direction by which the power window motor 10 is forwardly rotated, and the window glass is raised.

After the judgment of step 23, the process proceeds to step 31 to judge whether the full-closed state is attained or not. If the full-closed state is attained, the flag UP_EN is set to “0” (step 32) to stop the operation of the relay driver 14018, thereby invalidating a raising operation. Then, it is judged whether a lowering operation is conducted or not (step 33). If a lowering operation is not conducted, the value of the time counter is incremented in order to measure the switch operation acceptance inhibition period Tx (step 34). Thereafter, it is judged whether the value of the time counter is larger than that corresponding to the switch operation acceptance inhibition period Tx or not (step 35).

If it is judged that the value of the time counter is not larger than that corresponding to the switch operation acceptance inhibition period Tx, the process returns to step 33. If the period Tx elapses, the value of the time counter is returned to the initial value or “0” (step 36). If a raising operation is conducted during the switch operation acceptance inhibition period Tx, the process jumps from step 33 to step 36. In step 36, the value of the time counter is returned to the initial value. Then, the flag UP_EN is set to “1” (step 37) to enable a raising operation, and thereafter the process returns to step 23. By contrast, if it is judged in step 31 that the full-closed state is not attained, the process returns directly to step 23.

When a foreign object is caught in the course of conducting a raising operation to raise the window glass and a lock current is produced, the resulting state is identical with that of the detection of the full closing in step 31, and hence the raising operation is invalidated only for the switch operation acceptance inhibition period Tx, or a further raising operation cannot be conducted unless a lowering operation is conducted during the period.

As described above, in the power window apparatus of the embodiment, when an operation of lowering the window glass is conducted to attain the full-opened state and the lock current flows, a lowering operation is inhibited from being accepted only for the switch operation acceptance inhibition period Tx, thereby preventing the lock current from continuously flowing to the power window motor 10. When a raising operation is conducted after elapse of the switch operation acceptance inhibition period Tx or during the switch operation acceptance inhibition period Tx, the power window motor 10 is operated in the direction of closing the window glass, and the state of inhibiting the acceptance of a lowering operation is canceled. Similarly, when an operation of raising the window glass is conducted to attain the full-closed state and the lock current flows, a raising operation is inhibited from being accepted only for the switch operation acceptance inhibition period Tx, thereby preventing the lock current from continuously flowing to the power window motor 10. When a lowering operation is conducted after elapse of the switch operation acceptance inhibition period Tx or during the switch operation acceptance inhibition period Tx, the power window motor 10 is operated in the direction of opening the window glass, and the state of inhibiting the acceptance of a raising operation is canceled. In the case where, during a raising operation, a foreign object is caught before the full-closed state is attained, and the lock current flows, a further raising operation is inhibited from being accepted only for the switch operation acceptance inhibition period Tx, thereby preventing the lock current from continuously flowing. When a lowering operation is conducted after elapse of the switch operation acceptance inhibition period Tx or during the switch operation acceptance inhibition period Tx, the power window motor 10 is operated in the direction of opening the window glass, and the state of inhibiting acceptance of the raising operation is canceled.

Therefore, the lock current does not continuously flow for the switch operation acceptance inhibition period Tx after the timing when the locked state is set, so that the lock current does not continuously flow after the timing when the locked state is set. Consequently, heat generation of the FET 1402 is suppressed, so that the FET 1402 can be prevented from being thermally broken, and the life of the FET can be prolonged. When the switch operation acceptance inhibition period Tx elapses, a switch operation in the same direction is again enabled. In the case where the window glass is erroneously stopped in the course of fully closing the window glass because of, for example, change over time of a door, even when a lowering operation is not conducted, a raising operation is again enabled after elapse of the switch operation acceptance inhibition period Tx, with the result that the possibility that the window glass can be fully closed is enhanced. Since the possibility that the window glass can be fully closed is enhanced, it is expected that an anticrime measure against vehicle theft and the like can be improved.

In the embodiments described above, the motor drive apparatus is a power window apparatus. It is a matter of course that the invention can be applied also to another apparatus. For example, the invention can be applied to an electric mirror, a power seat, etc.

According to the motor drive apparatus of the invention according to (1) above, when the motor current in the case where the motor-driven movable member is moved reaches the lock current, a switch operation of the movement direction of the movable member at the timing is invalidated, and, when a switch operation of moving the movable member in the opposite direction is conducted under the state where a switch operation is invalidated, the switch operation invalidation setting state is cancelled. Therefore, the lock current does not continuously flow after the timing when the locked state is set. Consequently, heat generation of a semiconductor device for supplying a current to the motor is suppressed, so that the device can be prevented from being thermally broken, and the life of the device can be prolonged.

According to the motor drive apparatus of the invention according to (2) above, when the motor current in the case where the motor-driven movable member is moved reaches the lock current, a switch operation of the movement direction of the movable member is invalidated for the predetermined period with starting from this timing, and, when a switch operation of moving the movable member in the opposite direction is conducted during the period in which a switch operation is invalidated, the switch operation invalidation setting state is cancelled. When the motor current is equal to the lock current even at a timing when the predetermined period elapses, a switch operation in the same direction is again invalidated only for the predetermined period. Therefore, the lock current does not continuously flow for the predetermined period after the timing when the locked state is set. Consequently, heat generation of a semiconductor device for supplying a current to the motor is suppressed, so that the device can be prevented from being thermally broken, and the life of the device can be prolonged. When the predetermined period of invalidating a switch operation elapses, a switch operation in the same direction is again enabled. In the case where the window glass is erroneously stopped in the course of fully closing the window glass because of, for example, change over time of a door, even when a lowering operation is not conducted, a raising operation is again enabled after elapse of the predetermined period, with the result that the possibility that the window glass can be fully closed is enhanced. Since the possibility that the window glass can be fully closed is enhanced, it is expected that an anticrime measure against vehicle theft and the like can be improved.

According to the method of controlling an operation on a motor movable member of the invention according to (3) above, when the motor current in the case where the motor driven movable member is moved reaches the lock current, a switch operation of the movement direction of the movable member at the timing is invalidated, and, when a switch operation of moving the movable member in the opposite direction is conducted under the state where a switch operation is invalidated, the switch operation invalidation setting state is cancelled. Therefore, the lock current does not continuously flow after the timing when the locked state is set. Consequently, heat generation of a semiconductor device for supplying a current to the motor is suppressed, so that the device can be prevented from being thermally broken, and the life of the device can be prolonged.

According to the method of controlling an operation on a motor movable member of the invention according to (4) above, when the motor current in the case where the motor-driven movable member is moved reaches the lock current, a switch operation of the movement direction of the movable member is invalidated for the predetermined period with starting from this timing, and, when a switch operation of moving the movable member in the opposite direction is conducted during the period in which a switch operation is invalidated, the switch-operation invalidation setting state is cancelled. When the motor current is equal to the lock current even at a timing when the predetermined period elapses, a switch operation in the same direction is again invalidated only for the predetermined period. Therefore, the lock current does not continuously flow for the predetermined period after the timing when the locked state is set. Consequently, heat generation of a semiconductor device for supplying a current to the motor is suppressed, so that the device can be prevented from being thermally broken, and the life of the device can be prolonged. When the predetermined period of invalidating a switch operation elapses, a switch operation in the same direction is again enabled. In the case where the window glass is erroneously stopped in the course of fully closing the window glass because of, for example, change over time of a door, even when a lowering operation is not conducted, a raising operation is again enabled after elapse of the predetermined period, with the result that the possibility that the window glass can be fully closed is enhanced. Since the possibility that the window glass can be fully closed is enhanced, it is expected that an anticrime measure against vehicle theft and the like can be improved.

What is claimed is:

1. A motor drive apparatus comprising:
a motor current detecting section which detects a motor current when a movable member driven by a motor is moved;
a lock current judging section which monitors the motor current detected by the motor current detecting section to make a judgment on a lock current that is to flow when motion of the movable member is set to a locked state;
a switch operation invalidation setting section which, when a judgment that the motor current when the movable member is moved is the lock current is made, invalidates a switch operation in a movement direction of the movable member at a timing of the judgment; and
a switch operation invalidation setting canceling section which, when a switch operation of moving the movable member in an opposite direction is conducted under a state where invalidation of a switch operation is set by the switch operation invalidation setting section, cancels the setting of switch operation invalidation by the switch operation invalidation setting section.

2. A motor drive apparatus comprising:
a motor current detecting section which detects a motor current when a movable member driven by a motor is moved;
a lock current judging section which monitors the motor current detected by the motor current detecting section to make a judgment on a lock current that is to flow when motion of the movable member is set to a locked state;
a switch operation invalidation setting section which, when a judgment that the motor current when the movable member is moved is the lock current is made, invalidates a switch operation of a movement direction of the movable member at a timing of the judgment, only for a predetermined period; and
a switch operation invalidation setting canceling section which, when a switch operation of moving the movable member in an opposite direction is conducted under a state where invalidation of a switch operation is set by the switch operation invalidation setting section, cancels the setting of switch operation invalidation by the switch operation invalidation setting section.

3. A method of controlling an operation on a movable member driven by a motor, the method comprising the steps of:
invalidating, when a motor current in a case where the movable member is moved reaches a lock current that is to flow when motion of the movable member is set to a locked state, a switch operation in a direction of moving the movable member at this timing; and
canceling the switch operation invalidation setting state by conducting a switch operation of moving the movable member in an opposite direction under a state where the switch operation is invalidated.

4. A method of controlling an operation on a movable member driven by a motor, the method comprising the steps of:
invalidating, when a motor current in a case where the movable member is moved reaches a lock current that is to flow when motion of the movable member is set to a locked state, a switch operation in a direction of moving the movable member at this timing only for a predetermined period;
canceling the switch operation invalidation setting state by conducting a switch operation of moving the movable member in an opposite direction during the predetermined period of invalidating a switch operation; and
invalidating again, when the motor current corresponds to the lock current even at a timing when the predetermined period elapses, a switch operation in the same direction only for the predetermined period.
